(19) United States
(12) Patent Application Publication
(10) Pub. No.: US 2006/0246239 A1
(43) Pub. Date: Nov. 2, 2006

(54) Porous inkjet recording material

(76) Inventors: Tienteh Chen, San Diego, CA (US); Eric L. Burch, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/119,078

(22) Filed: Apr. 29, 2005

(51) Int. Cl. B41M 5/00

(52) U.S. Cl. 428/32.34

(57) ABSTRACT

In one aspect of the present system and method, an ink receiving substrate includes a photobase layer, a layer of inorganic oxide dispensed on the photobase layer, and a layer of colloidal inorganic oxide formed on the layer of inorganic oxide.

### BACKGROUND

Inkjet printing has become a popular way of recording images on various media surfaces, particularly paper, for a number of reasons, including, low printer noise, capability of high-speed recording, and multi-color recording. Additionally, these advantages of inkjet printing can be obtained at a relatively low price to consumers. Though there has been great improvement in inkjet printing, improvements are followed by increased demands from consumers for higher speeds, higher resolution, full color image formation, increased stability, etc.

In recent years, as digital cameras and other digital image collecting devices have advanced, image recording technology has attempted to keep pace by improving inkjet image recording on paper sheets and the like. The desired quality level of the inkjet recorded images (“hard copy”) is that of traditional silver halide photography. In other words, consumers would like inkjet recorded images that have the color reproduction, image density, gloss, etc. that is as close to those of silver halide photography as possible.

Traditional recording sheets for the inkjet printing process are not adequate to provide silver halide quality images. Particularly, there is a need to improve ink absorptiveness, ink absorption rate, image quality, water fastness and light stability.

### SUMMARY

In one aspect of the present system and method, an ink receiving substrate includes a photobase layer, a layer of inorganic oxide dispensed on the photobase layer, and a layer of colloidal inorganic oxide formed on the layer of fumed silica or alumina.

In another embodiment, a method for forming an ink receiving substrate includes providing a photobase layer dispensing a layer of inorganic oxide on the photobase layer, and forming a layer of colloidal inorganic oxide on the layer of inorganic oxide.

### BRIEF DESCRIPTION OF THE DRAWINGS

The accompanying drawing illustrates various embodiments of the present system and method and is a part of the specification. The illustrated embodiments are merely examples of the present system and method and do not limit the scope thereof.

FIG. 1 is a simple block diagram illustrating an inkjet material dispensing system, according to one exemplary embodiment.

FIG. 2 is a side cross-sectional view illustrating the layers of a porous inkjet recording substrate, according to one exemplary embodiment.

Throughout the drawings, identical reference numbers designate similar, but not necessarily identical, elements.

### DETAILED DESCRIPTION

The present specification discloses an exemplary porous ink recording material having improved image quality. According to one exemplary embodiment disclosed herein, the porous ink recording material includes a thin colloidal inorganic oxide layer to improve the poor coalescence, slow inkjet absorption rate, and bronzing of traditional porous inkjet materials based on organic treated silica. Further details of the present ink recording material will be provided below.

Before particular embodiments of the present system and method are disclosed and described, it is to be understood that the present system and method are not limited to the particular process and materials disclosed herein as such may vary to some degree. It is also to be understood that the terminology used herein is used for the purpose of describing particular embodiments only and is not intended to be limiting, as the scope of the present system and method will be defined only by the appended claims and equivalents thereof.

As used in the present specification and in the appended claims, the term “liquid vehicle” is defined to include liquid compositions that can be used to carry colorants, including pigments, to a substrate. Liquid vehicles are well known in the art, and a wide variety of liquid vehicle components may be used in accordance with embodiments of the present exemplary system and method. Such liquid vehicles may include a mixture of a variety of different agents, including without limitation, surfactants, co-solvents, buffers, biocides, viscosity modifiers, sequestering agents, stabilizing agents, and water. Though not liquid per se, the liquid vehicle can also carry other solids, such as polymers, UV curable materials, plasticizers, salts, etc.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of approximately 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

Additionally, as used herein, the term “bronzing” shall be understood to refer to an undesired stacking of dye or pigment on an ink receiving media due to slow ink absorption rates.

In the following description, for purposes of explanation, numerous specific details are set forth in order to provide a thorough understanding of the present system and method for producing an exemplary porous ink recording material having improved image quality. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

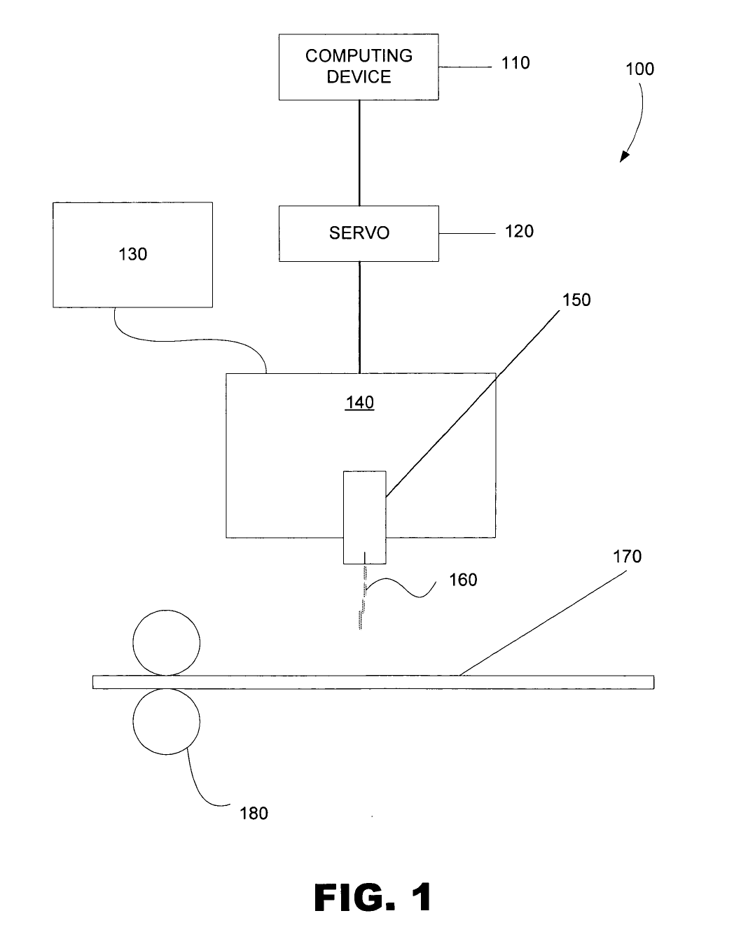

FIG. 1 illustrates an exemplary system (100) that may be used to apply a pigment-based inkjet ink (160) to an ink receiving substrate (170), according to one exemplary embodiment. As shown in FIG. 1, the present system includes a computing device (110) controllably coupled through a servo mechanism (120) to a moveable carriage (140) having an inkjet dispenser (150) disposed thereon. A material reservoir (130) is coupled to the moveable carriage (140), and consequently to the inkjet print head (150). A number of rollers (180) are located adjacent to the inkjet dispenser (150) configured to selectively position an ink receiving substrate (170). The above-mentioned components of the present exemplary system (100) will now be described in further detail below.

The computing device (110) that is controllably coupled to the servo mechanism (120), as shown in FIG. 1, controls the selective deposition of an inkjet ink (160) on an ink receiving substrate (170). A representation of a desired image or text may be formed using a program hosted by the computing device (110). That representation may then be converted into servo instructions that are then housed in a processor readable medium (not shown). When accessed by the computing device (110), the instructions housed in the processor readable medium may be used to control the servo mechanisms (120) as well as the movable carriage (140) and inkjet dispenser (150). The computing device (110) illustrated in FIG. 1 may be, but is in no way limited to, a workstation, a personal computer, a laptop, a digital camera, a personal digital assistant (PDA), or any other processor containing device.

The moveable carriage (140) of the present printing system (100) illustrated in FIG. 1 is a moveable material dispenser that may include any number of inkjet material dispensers (150) configured to dispense the inkjet ink (160). The moveable carriage (140) may be controlled by a computing device (110) and may be controllably moved by, for example, a shaft system, a belt system, a chain system, etc. making up the servo mechanism (120). As the moveable carriage (140) operates, the computing device (110) may inform a user of operating conditions as well as provide the user with a user interface.

As an image or text is printed on the ink receiving substrate (170), the computing device (110) may controllably position the moveable carriage (140) and direct one or more of the inkjet dispensers (150) to selectively dispense an inkjet ink at predetermined locations on the ink receiving substrate (170) as digitally addressed drops, thereby forming the desired image or text. The inkjet material dispensers (150) used by the present printing system (100) may be any type of inkjet dispenser configured to perform the present method including, but in no way limited to, thermally actuated inkjet dispensers, mechanically actuated inkjet dispensers, electrostatically actuated inkjet dispensers, magnetically actuated dispensers, piezoelectrically actuated dispensers, continuous inkjet dispensers, etc. Additionally, the present ink receiving substrate (170) may receive inks from non-inkjet sources such as, but in no way limited to, screen printing, stamping, pressing, gravure printing, and the like.

The material reservoir (130) that is fluidly coupled to the inkjet material dispenser (150) houses and supplies an inkjet ink (160) to the inkjet material dispenser. The material reservoir may be any container configured to hermetically seal the pigment-based inkjet ink (160) prior to printing.

FIG. 1 also illustrates the components of the present system that facilitate reception of the pigment-based inkjet ink (160) onto the ink receiving substrate (170). As shown in FIG. 1, a number of positioning rollers (180) may transport and/or positionally secure an ink receiving substrate (170) during a printing operation. Alternatively, any number of belts, rollers, substrates, or other transport devices may be used to transport and/or postionally secure the ink receiving substrate (170) during a printing operation, as is well known in the art.

The present system and methods provide a porous ink receiving substrate (170) with enhanced image quality, the composition of which will now be described in detail below.

Exemplary Composition

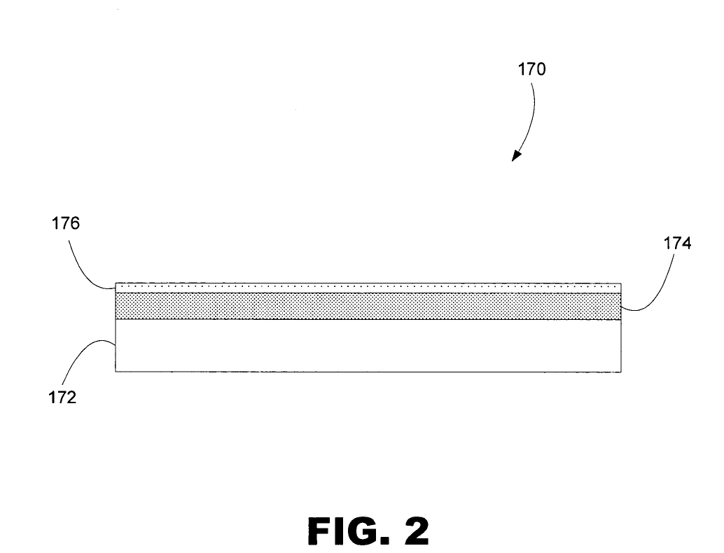

One exemplary composition of the present exemplary ink receiving substrate (170) configured to receive an inkjet ink (160) is illustrated in FIG. 2. As shown in FIG. 2, the present exemplary ink receiving substrate (170) includes a photobase layer (172), a layer of fumed silica or alumina treated with silane coupling agents containing functional groups (174), and a layer of colloidal inorganic oxide (176). As a result of the present formulation, the disclosed ink receiving substrate (170) improves the poor coalescence, slow inkjet absorption rate, and bronzing of traditional porous inkjet materials based on organic treated silica while providing a high gloss finish and scratch resistance with little or no post-processing. The individual components of the present ink receiving substrate (170) will be described in further detail below.

Photobase Paper

The present exemplary ink receiving substrate (170) is formed on a photobase layer (172) or support. According to one exemplary embodiment, any number of the usual photobase supports used in the manufacture of transparent or opaque photographic material may also be employed in the practice of the present system and method. Examples include, but are not limited to, clear films, such a cellulose esters, including cellulose triacetate, cellulose acetate, cellulose propionate, or cellulose acetate butyrate, polyesters, including poly(ethylene terephthalate), polyimides, polycarbonates, polyamides, polyolefins, poly(vinyl acetals), polyethers, polyvinyl chloride, and polysulfonamides. Polyester film supports, and especially poly(ethylene terephthalate), such as manufactured by du Pont de Nemours under the trade designation of MELINEX, may be selected because of their excellent dimensional stability characteristics. Further, opaque photographic materials may be used as the photobase layer (172) including, but in no way limited to, baryta paper, polyethylene-coated papers, and voided polyester.

Non-photographic materials, such as transparent films for overhead projectors, may also be used for the support material. Examples of such transparent films include, but are not limited to, polyesters, diacetates, triacetates, polystyrenes, polyethylenes, polycarbonates, polymethacrylates, cellophane, celluloid, polyvinyl chlorides, polyvinylidene chlorides, polysulfones, and polyimides.

Additional support materials that may be incorporated by the present system and method to serve as the photobase layer (172) include plain paper of various different types, including, but in no way limited to, pigmented papers and cast-coated papers, as well as metal foils, such as foils made from alumina.

Fumed Silica or Alumina Treated with Silane Coupling Agents Containing Functional Groups

As illustrated in FIG. 2, the photobase layer (172) is coated on at least one surface with inorganic oxide groups, such as a fumed silica or alumina, treated with silane coupling agents containing functional groups (174). The dry coatweight of the first layer of fumed silica or alumina treated with silane coupling agents containing functional groups (174) is about 20 to 50 GSM but preferably from 25 to 35 GSM. According to one exemplary embodiment, the lower alumina-containing or fumed silica containing basecoat serves to attract the solvent(s) comprising the inkjet ink vehicle, thereby aiding in relatively rapid drying of an ink printed thereon.

According to one exemplary embodiment, the photobase layer (172) is coated with fumed silica. The fumed silica is treated with the silane coupling agents containing functional groups and then disposed on the photobase layer (172). According to this exemplary embodiment, the fumed silica may be any silica in colloidal form. Specifically, according to one exemplary embodiment, the aggregate size of the fumed silica is between approximately 50 to 300 nm in size. More specifically, the fumed silica is preferred between approximately 100 to 250 nm in size. The Brunauer-Emmett-Teller (BET) surface area of the fumed silica is between approximately 100 to 350 square meters per gram. More specifically, the fumed silica is preferred to have a BET surface area of 150 to 250 square meters per gram. Accordingly, the zeta potential, or the electrokinetic measurement used to control the stability of a colloid, of the organic treated silica at a pH of 3.5 is at least 20 mV.

Alternatively, the photobase layer (172) may be coated with an alumina that is similarly treated with the silane coupling agents containing functional groups. According to one exemplary embodiment, the alumina coating comprises pseudo-boehmite, which is aluminum oxide/hydroxide (Al₂O₃.n H₂O where n is from 1 to 1.5). More preferably, the photobase layer (172) is coated with an alumina that comprises rare earth-modified boehmite, containing from about 0.04 to 4.2 mole percent of at least one rare earth metal having an atomic number from 57 to 71 of the Periodic Table of Elements. According to this exemplary embodiment, the rare earth elements are selected from the group consisting of lanthanum, ytterbium, cerium, neodymium, praseodymium, and mixtures thereof. The presence of the rare earth changes the pseudo-boehmite structure to the boehmite structure. The presence of the rare earth element provides superior lightfastness, compared with an alumina basecoat not including the rare earth element. The preparation of the pseudo-boehmite layer modified with rare earths is more fully described in U.S. Pat. No. 6,156,419, the contents of which are incorporated herein by reference.

As mentioned above, the layer of fumed silica or alumina is treated with silane coupling agents containing functional groups. According to one exemplary embodiment, the silane coupling agents contain functional groups such as primary amine, secondary amine, tertiary amine, quaternary amine, etc. According to one exemplary embodiment, the silane coupling agent with the amine functional group is used to convert the anionic silica to a cationic silica that is configure dot fix an anionic dye that is dispensed thereon.

To further illustrate the treatment of the fumed silica or alumina with silane, Formula 1 below provides exemplary organosilane reagents that may be used to treat the fumed silica or alumina, according to one exemplary embodiment:

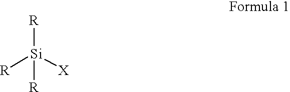

In Formula 1 above, from 0 to 2 of the R groups can be H, —CH₃, —CH₂CH₃, or —CH₂CH₂CH₃; from 1 to 3 of the R groups can be halo, hydroxy, or alkoxy; and X may be an active functional group containing primary, secondary, tertiary, and quaternary amines, according to one exemplary embodiment. If halo is present, then Formula 1 can be said to be an organohalosilane reagent. If alkoxy is present, then Formula 1 can be said to be an organoalkoxysilane reagent. If hydroxyl is present, then Formula 1 can be said to be an organosilanol reagent.

According to one exemplary embodiment, the silane coupling agents may include, but are in no way limited to, aminopropyltriethoxysilane, aminopropyltrimethoxysilane, aminopropylmethyldiethoxysilane, aminopropylmethyldimethoxysilane, aminoethylaminopropyltrimethoxysilane, aminoethylaminopropyltriethoxysilane, aminoethylaminopropylmethyldimethoxysilane, diethylenetriaminopropyltrimethoxysilane, diethylemetriaminopropyltriethyxysilane, diethylenetriaminopropylmethyldimethoxysilane, diethylenetriaminopropylmethyldiethoxysilane, cyclohexylaminopropyltrimethoxysilane, hexanediaminomethyltriethoxysilane, anilinomethyltrimethoxysilane, anilinomethyltriethoxysilane, diethylaminomethyltriethoxysilane, (diethylaminomethyl)methyldiethoxysilane, methylaminopropyltrimethoxysilane, aminopropylsilsesquioxane, aminopropylsilanetriol, aminoethylaminopropysilantriol, aminoethylaminopropylsilsesquioxane, bis-(gamma-trimethoxysilylpropyl)amine, N-phenyl-gamma-aminopropyltrimethoxysilane, n-butylaminopropyltrimethoxysilane, t-butylaminopropyltrimethoxysilane, -aminophenyltrimethoxysilane, N-(2-aminoethyl)-3-aminopropylsilanetriol, N-(6-aminohexyl)aminomethyltrimethoxysilane, N-(3-trimethoxysilylpropyl)4,5-dihydroimidazole, N-(6-aminohexyl)aminopropyltrimethoxysilane, trimethylaminopropyltimethoxysilane (Chloride Salt), tributylaminopropyltimethoxysilane (Chloride Salt), and the like. According to one exemplary embodiment of the present system and method, the amount of silane coupling agent used may vary from approximately 0.1 to 30% based on the weight of the silica or alumina. A more preferred range of the silane coupling agent used may vary from approximately 1 to 10% by weight based on the weight of fumed silica or alumina.

In addition to the organic silane coupling agents defined in Formula 1 above, inorganic treatment agents such as aluminum chlorohydrate may also be used concurrently with the organic silane coupling agents. As used herein, “aluminum chloride hydrate,” “ACH,” “polyaluminum chloride,” “PAC,” “polyaluminum hydroxychloride,” and the like, refers to a class of soluble aluminum products in which aluminum chloride has been at least partly reacted with a base. The relative amount of OH—, compared to the amount of Al, can determine the basicity of a particular product. The chemistry of ACH is often expressed in the form Alₙ(OH)ₘCl(₃ₙ₋ₘ), wherein n can vary from 1 to 50, and m may vary from 1 to 150. An exemplary stable ionic species in ACH can have the formula [Al₁₂(OH)₂₄AlO₄(H₂O)₁₂]⁷⁺. Other examples of acceptable inorganic treatment agents such as aluminum chlorohydrate include, but are in no way limited to, [Al₆(OH)₁₅]³⁺, [Al₈(OH)₂₀]⁴⁺, [Al₁₃(OH)₃₄]⁵⁺, [Al₂₁(OH)₆₀]³⁺, etc. Examples of the above mentioned aluminum chlorohydrate (ACH) may be commercially found under the names Aloxicoll, Aluminol ACH, Aquarhone, Cartafix LA, Ekoflock 90, GenPac 4370, Gilufloc 83,; Hessidrex WT, HPB 5025, Hydral, Hydrofugal, Hyper Ion 1026, Hyperdrol, Kempac 10, Kempac 20, Kemwater PAX 14, Locron, Locron P, Locron S, Nalco 8676, Prodefloc, and Sulzfloc JG.

The weight ratio between organic and inorganic treatment in layer (174) is from approximately 5:95 to 100:0. According to another exemplary embodiment, the weight ratio between organic and inorganic treatment in layer (174) may vary from approximately 20:80 to 70:30.

Additionally, other silane coupling agents containing other functional groups such as thiol, mercapton, ureido, hydroxyl, poly(ethyleneoxide), imidazole, pyridine, sulfonate, carboxylate, etc. may be incorporated by the present exemplary composition.

According to the present exemplary embodiment, the binder/silica or alumina ratio is from approximately 10 to 30 parts based on silica or alumina. Appropriate binders for the organic treated silica include, but are in no way limited to, polyvinylalcohol with % hydrolysis from 70 to 99%, derivatized polyvinylalcohol (cationic, acetoacetylated, etc.), copolymer of polyvinylalcohol and poly(ethylene oxide), gelatin, polyvinylpyrrolidone, low Tg synthetic polymer latex, and mixtures thereof.

In addition to the above-mentioned components, the fumed silica or alumina treated with silane coupling agents containing functional groups (174) may also contain any number of surfactants, buffers, plasticizers, and other additives that are well known in the art.

During application, the fumed silica or alumina treated with silane coupling agents containing functional groups (174) can be coated onto the photobase layer (172) by any number of material dispensing machines and/or methods including, but in no way limited to, a slot coater, a curtain coater, a cascade coater, a blade coater, a rod coater, a gravure coater, a Mylar rod coater, a wired coater, and the like.

Colloidal Inorganic Oxides

As illustrated in FIG. 2, the one or more layers of fumed silica or alumina treated with silane coupling agents containing functional groups (174) is coated with a layer of colloidal inorganic oxides (176). According to the present exemplary embodiment, the colloidal inorganic oxide can be anionic, cationic, or nonionic. Types of colloidal inorganic oxides include, but are in no way limited to, colloidal silica, colloidal aluminum oxide (or alumina), colloidal zinc oxide, colloidal titanium oxide, colloidal zirconia, colloidal antimony pentoxide, colloidal ceria, colloidal tin oxide, and colloidal Yttria. Further, the colloidal inorganic oxide (176) may be spherical colloidal silica, according to one exemplary embodiment.

According to one exemplary embodiment, the particle size of the colloidal inorganic oxide suitable for the present application is from between approximately 5 to 100 nm. According to another exemplary embodiment, the particle size of the colloidal inorganic oxide is between approximately 10 and 70 nm. Further, according to the present exemplary embodiment, the binder/inorganic oxide ratio of the colloidal inorganic oxide layer (176) is from approximately 0 to 5% binder based on silica content. According to another exemplary embodiment, the binder/inorganic oxide ratio of the colloidal inorganic oxide (176) is from approximately 0 to 2%. Further, according to the present exemplary embodiment, the coatweight of the colloidal inorganic oxide layer (176) may range from approximately 0.05 to 5 GSM. According to another exemplary embodiment, the coatweight of the colloidal inorganic oxide layer (176) may range from approximately 0.05 to 2 GSM.

As used in the present exemplary system and method, any number of commercially available colloidal inorganic oxide may be used to coat the one or more layers of fumed silica or alumina treated with silane coupling agents containing functional groups (174) including, but in no way limited to, Cartacoat® K produced by Clariant Chemical; Snowtex® ST-O, ST-OL, ST-20L, and ST-C produced by Nissan Chemical; Ludox® CL, AM and TMA produced by Grace-Davison Chemical; Nyacol®AL20, Nyacol® AL20, Nyacol® A1530, Nyacol®CeO2, Nyacol SN15, Nyacol® DP5370, and NYACOL®Zr50/20 produced by Nyacol Nano Technologies. In addition to the above-mentioned elements, the colloidal inorganic oxide layer (176) may also include surfactants configured to lower the surface tension of the colloidal inorganic oxide layer (176) to ensure good wetting and spreading during ink deposition. According to one exemplary embodiment, the colloidal inorganic oxide layer (176) may include, but is in no way limited to, typical water-soluble surfactants including ethoxylated octylphenols such as TRITONS™, alkyl phenoxypoly (ethleneoxy) ethanols such as IGEPALS™, silicone glycol copolymers including polyalkylene oxide-modified polydimethylsiloxanes such as SILWETS™, ethoxlyated tetramethyl decyndiols such as SURFYNOLS™, ethoxylated trimethylnonanols such as TERGITOLS™, polyoxyethylene ethers such as BRIJS™, ethylene oxide/propylene oxide copolymers such as PLURONICS™, fluorosurfactants such as FLUORADS™ and ZONYLS™, and nonionic ethoxylated surfactants such as NEODOLS™. Other exemplary surfactants that can be used include, but are in no way limited to, Wetting Olin10G, alkyl polyethylene oxides, alkyl phenyl polyethylene oxides, polyethylene oxide (PEO) block copolymers, acetylenic PEO, PEO esters, PEO amines, PEO amides, and dimethicone copolyols, cationic surfactants such as cetyltrimethylammonium bromide (CTAB), and anionic surfactant such as sodium dodecyl sulfate (SDS). According to one exemplary embodiment, any of these surfactants, or combinations of these surfactants or other surfactants, can be present at from approximately 0.01 wt % to about 10 wt % of the ink-jet ink composition. According to an exemplary embodiment, a nonionic fluoro surfactant, e.g. Zonyl FSN, is selected.

The colloidal inorganic oxide layer (176) may also include a thickener to facilitate the coating thereof. According to one exemplary embodiment, the thickener may include, but is in no way limited to, cellulose, hydroxymethyl cellulose, hydroxyethylcellulose, hydroxypropylcellulose, carboxylated cellulose, high MW polyvinyl alcohol, gelatin, and/or synthetic associate thickeners (e.g. base swellable thickener). Commercially available thickeners may be found under the trade names Drewthix, UCAR® POLYPHOBE RHEOTECH, TEXIPOL, COAPUR, etc.

According to one exemplary embodiment, the colloidal inorganic oxide layer (176) can be coated simultaneously with the inorganic oxide groups, such as a fumed silica or alumina, treated with silane coupling agents containing functional groups (174) in a manner known as wet-on-wet using any number of material dispensing machines and/or methods including, but in no way limited to, a slot coater, a curtain coater, a cascade coater, a blade coater, and the like.

Alternatively, the colloidal inorganic oxide layer (176) can be coated onto a dried layer or semidried layer of inorganic oxide groups treated with silane coupling agents containing functional groups (174), using a process commonly known as wet-on dry, using any of the above-mentioned machines and/or methods.

According to one exemplary embodiment, the colloidal inorganic oxide layer (176) is coated to form a top layer having a thickness between approximately 0.14 to 2.8 μm. According to this exemplary embodiment, the thickness range of the colloidal inorganic oxide layer (176) is based on four considerations, namely, (1) color gamut, (2) gloss, (3) scratch resistance, and (4) dry rub. More specifically, at the lower end of the above-mentioned range, a desired gloss and gamut are achieved.

Further, at the upper thickness range of approximately 2.8 μm there is a tradeoff in properties that may be marginal, but good scratch resistance is achieved. Particularly, three parameters (color gamut, gloss, and dry rub) are considered to be borderline, but the scratch resistance is acceptable. Specifically, for the upper range, improvements in scratch are evident up to 4 μm thickness, but the tradeoffs in gamut, gloss, and dry rub become more severe as the thickness is increased. At 2.2 μm, there is an improvement in scratch, a slight degradation in color gamut, and a severe tradeoff in gloss (relative to uncoated material).

When an ink (160) is dispensed on the above-mentioned ink receiving substrate (170), a number of interactions may occur, depending on the composition of the ink (160) being dispensed. When a dye based ink is dispensed on the ink receiving substrate (170), additives and co-solvents of the dye based ink will penetrate through the colloidal inorganic oxide layer (176) while some dye will be captured and remain on the colloidal inorganic oxide layer. For pigmented ink, the pigment will stay on top of the colloidal inorganic oxide layer (176) while the other ink components are allowed to pass to the layer containing inorganic oxide groups treated with silane coupling agents containing functional groups (174). Once the ink is deposited onto the sub layer of inorganic oxide groups treated with silane coupling agents containing functional groups, the dye portion of the ink will be fixed on the surface of the silica, while other components of ink will fill in the voids of the layer containing inorganic oxide groups (174).

According to the present exemplary embodiment, the colloidal inorganic oxide layer (176) is formed on the layer containing inorganic oxide groups (174) to increase surface tension of the ink receiving substrate (170) allowing improved wetting and spreading of ink on the surface of the ink receiving substrate (170). As a result of the improved wetting and spreading of the ink on the surface of the ink receiving substrate, the ink absorption rate is improved and the chance of ink coalescence is reduced. Additionally, the increased absorption rate reduces the likelihood of bronzing due to stacking of the dye or pigment.

### EXAMPLE

According to a first exemplary embodiment, a number of ink receiving substrates were prepared with varying top layers with varying coatweights. An inkjet ink was then jetted onto the various ink receiving substrates and optically analyzed for coalescence and bronzing qualities. The elements of the ink receiving substrates are illustrated in Table 1 below. Typical treatment of fumed silica or alumina with organic silane coupling agents was carried out in aqueous solution with careful pH control and addition rate. According to one exemplary embodiment, the pH range for the treatment is maintained between a pH of approximately 2 and 6. Additionally, the treatment process can be accelerated by raising the temperature of the reaction. According to one exemplary embodiment, the temperature is maintained between approximately 50 to 90° C. Normally, the reaction will be complete within one hour at 80° C.

TABLE 1

| | Bottom Layer | | Upper Layer | | Coalescence | Bronzing | Remark |
|---|---|---|---|---|---|---|---|
| | | Coatweight | | Coatweight | 1-5 | 1-5 | T—test |
| I.D. | Composition | (GSM) | Composition | (GSM) | (5 best) | (5 best) | C—control |
| 1 | PG022 modified with 3% A-1120 | 28.5 | Cartacoat K320 | none | 2 | 1 | C |
| 2 | PG022 modified with 3% A-1120 | 28.5 | Cartacoat K320 | 0.2 | 4 | 4 | T |
| 3 | PG022 modified with 3% A-1120 | 28.5 | Cartacoat K320 | 0.5 | 5 | 5 | T |
| 4 | PG022 modified with 3% A-1120 | 28.5 | Cartacoat K320 | 1.0 | 5 | 5 | T |
| 5 | OS1 modified with 3% A-1120 and 3% TMAPS | 31 | Cartacoat K320 | none | 2 | 1 | C |
| 6 | OS1 modified with 3% A-1120 and 3% TMAPS | 31 | Cartacoat K320 | 0.2 | 4 | 4 | T |
| 7 | OS1 modified with 3% A-1120 and 3% TMAPS | 31 | Cartacoat K320 | 0.5 | 5 | 5 | T |
| 8 | OS1 modified with 3% A-1120 and 3% TMAPS | 31 | Cartacoat K320 | 1.0 | 5 | 5 | T |
| 9 | PG022 modified with 3% A-1120 | 30 | Nyacol AL20 | 0.2 | 5 | 5 | T |
| 10 | PG022 modified with 3% A-1120 | 30 | Nyacol A1530 | 0.2 | 5 | 5 | T |
| 11 | PG022 modified with 3% A-1120 | 30 | Nyacol CeO₂ | 0.2 | 5 | 5 | T |
| 12 | PG022 modified with 3% A-1120 | 30 | Nyacol SN15 | 0.2 | 5 | 5 | T |
| 13 | PG022 modified with 3% A-1120 | 30 | Nyacol DP5370 | 0.2 | 5 | 5 | T |
| 14 | PG022 modified with 3% A-1120 | 30 | NYACOL ® Zr50/20 | 0.2 | 5 | 5 | T |

As used in the formulations listed in Table 1, PG022 is a predispersed cationic fumed silica from Cabot corp., Cartacoat K320 is cationic colloidal silica from Clariant Chemicals., Mowiol 26-88 is PVA from Clariant Chemicals, OS1 is cationic fumed silica prepared from Cabot Cab-O-Sil M-5 with 0.5% aminoethylaminopropyltrimethoxy silane, TMAPS is trimethylaminopropyltri(methoxy)silane (chloride salt) from Gelest, and Silquest A-1120 is trade name of OSI chemicals. Further, Nyacol AL20 is colloidal aluminum oxide, Nyacol A1530 is colloidal antimony pentoxide, Nyacol CeO2 is colloidal ceria, Nyacol SN15 is colloidal tin oxide, Nyacol DP5370 is colloidal zinc oxide, NYACOL® Zr50/20 is colloidal zirconia, all from Nyacol Nano Technologies, Inc.

As shown in Table 1 above, ink receiving substrates 1 through 4 included a bottom layer of TT 2820-19 coated with a fumed silica dispersion in the form of PG022(3% A-1120), and a PVA binder in the form of 18 Mowiol 26-88 having a coatweight of 28.5GSM. Similarly, ink receiving substrates 5 through 8 had a bottom layer of TT 2820-53 coated with OS1+3%A-1120, 3% (TMAPS) having a coatweight of 28.5GSM. Other ingredients for the bottom ink absorptive layer include 3.5% boric acid, 1.4% glycerol, 2% thiodiethyleneglycol and the % solid is 15.5%. The upper layer also includes 1% Zonyl FSN surfactant and the % solid for the upper layer is 5%. As shown in Table 1, ink receiving substrates 1 and 5 were used as control samples without a top layer while ink receiving substrates 2-4 and 6-8 received layers of the colloidal silica Cartacoat® without binder in various coatweights.

After optical inspection of ink receiving substrates 1 through 8, the coalescence and bronzing performance of each substrate was graded on a scale of 1 to 5 with 5 being the best and 1 being the worst. As illustrated in Table 1, the coalescence and bronzing performance of the exemplary ink receiving substrates improved with an increase in the coatweight of the colloidal silica up to 1 g/m², thereby demonstrating the image quality enhancement properties of adding a layer of colloidal inorganic oxide to the ink receiving substrates.

In conclusion, the above-mentioned example illustrates a number of benefits that may be provided by the present exemplary system and method, according to one exemplary embodiment. More specifically, the disclosed ink receiving substrate composition having a thin colloidal inorganic oxide layer improves the poor coalescence, slow inkjet absorption rate, and bronzing of traditional porous inkjet materials based on organic treated silica.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. An ink receiving substrate comprising:
a photobase layer;
a layer of inorganic oxide dispensed on said photobase layer; and
a layer of colloidal inorganic oxides formed on said layer of inorganic oxide.

2. The ink receiving substrate of claim 1, wherein said layer of colloidal inorganic oxides has a thickness between approximately 0.14 and 2.8 μm.

3. The ink receiving substrate of claim 1, wherein said layer of colloidal inorganic oxides comprises one of a colloidal silica, a colloidal aluminum oxide, a colloidal alumina, a colloidal zinc oxide, a colloidal titanium oxide, a colloidal zirconia, a colloidal antimony pentoxide, a colloidal ceria, a colloidal tin oxide, or a colloidal Yttria.

4. The ink receiving substrate of claim 1, wherein said layer of inorganic oxide comprises one of a fumed silica or an alumina.

5. The ink receiving substrate of claim 4, wherein said layer of fumed silica or alumina is treated with silane coupling agents containing functional groups.

6. The ink receiving substrate of claim 5, wherein said silane coupling agents has the general structure of: 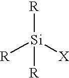
where from 0 to 2 of the R groups can be H, —CH₃, —CH₂CH₃, or —CH₂CH₂CH₃; from 1 to 3 of the R groups can be halo, hydroxy, or alkoxy; and X may be an active functional group containing primary, secondary, tertiary, and quaternary amines.

7. The ink receiving substrate of claim 6, wherein said silane coupling agent comprises one of an aminopropyltriethoxysilane, an aminopropyltrimethoxysilane, an aminopropylmethyldiethoxysilane, an aminopropylmethyldimethoxysilane, an aminoethylaminopropyltrimethoxysilane, an aminoethylaminopropyltriethoxysilane, an aminoethylaminopropylmethyldimethoxysilane, a diethylenetriaminopropyltrimethoxysilane, a diethylemetriaminopropyltriethyxysilane, a diethylenetriaminopropylmethyldimethoxysilane, a diethylenetriaminopropylmethyldiethoxysilane, a cyclohexylaminopropyltrimethoxysilane, a hexanediaminomethyltriethoxysilane, an anilinomethyltrimethoxysilane, an anilinomethyltriethoxysilane, a diethylaminomethyltriethoxysilane, a (diethylaminomethyl)methyldiethoxysilane, a methylaminopropyltrimethoxysilane, a aminopropylsilsesquioxane, a aminoethylaminopropylsilsesquioxane, a bis-(gamma-trimethoxysilylpropyl)amine, a N-phenyl-gamma-aminopropyltrimethoxysilane, a n-butylaminopropyltrimethoxysilane, a t-butylaminopropyltrimethoxysilane, -a aminophenyltrimethoxysilane, a N-(2-aminoethyl)-3-aminopropylsilanetriol, a aminopropylsilanetriol, a N-(6-aminohexyl)aminomethyltrimethoxysilane, a N-(3-trimethoxysilylpropyl)-4,5-dihydroimidazole, a N-(6-aminohexyl)aminopropyltrimethoxysilane, a trimethylaminopropyltimethoxysilane (Chloride Salt), or a tributylaminopropyltimethoxysilane (Chloride Salt).

8. The ink receiving substrate of claim 5, wherein said silane coupling agents comprises from approximately 1 to 30% of said layer of fumed silica or alumina based on a weight of said fumed silica or alumina.

9. The ink receiving substrate of claim 5, wherein said silane coupling agents comprises from approximately 1 to 10% of said layer of fumed silica or alumina based on a weight of said fumed silica or alumina.

10. The ink receiving substrate of claim 4, wherein said layer of fumed silica or alumina is treated with a combination of silane coupling agents and aluminum chlorohydrate.

11. The ink receiving substrate of claim 10, wherein said silane coupling agents contain one of a primary amine, a secondary amine, a tertiary amine, or a quaternary amine.

12. The ink receiving substrate of claim 10, wherein a weight ratio of the silane coupling agents and aluminum chlorohydrate is from approximately 100:0 to 0:100.

13. The ink receiving substrate of claim 10, wherein a total amount of silane coupling agents and aluminum chlorohydrate comprises from approximately 1 to 30% of said layer of fumed silica or alumina based on a weight of said fumed silica or alumina.

14. The ink receiving substrate of claim 4, wherein said layer of fumed silica comprises an aggregate size between approximately 50 to 350 nm.

15. The ink receiving substrate of claim 4, wherein said layer of fumed silica comprises an aggregate size between approximately 100 to 250 nm.

16. The ink receiving substrate of claim 4, wherein a Brunauer-Emmett-Teller (BET) surface area of fumed silica comprises between approximately 50 and 350 square meters per gram (m²/g).

17. The ink receiving substrate of claim 4, wherein a BET surface area of fumed alumina comprises between approximately 50 and 300 square meters per gram (m²/g).

18. The ink receiving substrate of claim 4, wherein said alumina layer comprises a pseudo-boehmite, a boehmite, or a fumed alumina,

19. The ink receiving substrate of claim 1, wherein said colloidal inorganic oxide layer comprises spherical colloidal silica.

20. The ink receiving substrate of claim 19, wherein an average particle size of said colloidal silica is between approximately 5 nm and 100 nm.

21. The ink receiving substrate of claim 19, wherein an average particle size of said colloidal silica is between approximately 10 nm and 70 nm.

22. The ink receiving substrate of claim 1, wherein said colloidal inorganic oxides layer further comprises a binder.

23. The ink receiving substrate of claim 22, wherein said colloidal inorganic oxides layer comprises between approximately 0 and 20% binder.

24. The ink receiving substrate of claim 22, wherein said colloidal inorganic oxides layer comprises between approximately 0 and 5% binder.

25. The ink receiving substrate of claim 1, wherein said colloidal inorganic oxides layer has a coatweight between approximately 0.05 and 5 grams per square meter (GSM).

26. The ink receiving substrate of claim 1, wherein said colloidal inorganic oxide layer has a coatweight between approximately 0.05 and 2 GSM.

27. The ink receiving substrate of claim 1, wherein said colloidal inorganic oxide layer comprises one of Cartacoat® K produced by Clariant Chemical; Snowtex® ST-O, ST-OL, ST-20L, or ST-C produced by Nissan Chemical; Ludox® CL, AM or TMA produced by Grace Davison.

28. The ink receiving substrate of claim 1, wherein said photobase layer comprises one of a clear film, an opaque photographic material, a transparent film, or a plain paper.

29. The ink receiving substrate of claim 28, wherein said clear film comprises one of a cellulose ester or a polyester.

30. The ink receiving substrate of claim 28, wherein said opaque photographic material comprises one of a baryta paper, a polyethylene-coated paper, or a voided polyester.

31. The ink receiving substrate of claim 1, wherein said layer of inorganic oxide dispensed on said photobase layer further comprises a binder.

32. The ink receiving substrate of claim 31, wherein said binder comprises poly vinyl alcohol (PVA).

33. The ink receiving substrate of claim 31, wherein said layer of inorganic oxide dispensed on said photobase layer further comprises one of a surfactant, a buffer, or a plasticizer.

34. A method for forming an ink receiving substrate comprising:
providing a photobase layer;
dispensing a layer of inorganic oxide on said photobase layer; and
forming a layer of colloidal inorganic oxide on said layer of inorganic oxide.

35. The method of claim 34, wherein dispensing a layer of organic oxide on said photobase paper comprises coating at least one side of said photobase paper with silica or alumina particles.

36. The method of claim 35, wherein said layer of organic oxide is coated onto said at least one side of said photobase paper by one of a slot coater, a curtain coater, a cascade coater, or a blade coater.

37. The method of claim 34, further comprising converting said inorganic oxide to a cationic state.

38. The method of claim 37, wherein converting said inorganic oxide to a cationic state comprises adding a silane coupling agent with an amine functional group to said organic oxide

39. The method of claim 37, further comprising adding one of a surfactant, a buffer, or a plasticizer to said layer of inorganic oxide.

40. The method of claim 34, wherein said photobase paper comprises one of a clear film, an opaque photographic material, a transparent film, or a plain paper

41. The method of claim 34, wherein forming a layer of colloidal inorganic oxides on said layer of inorganic oxide comprises performing a wet-on-wet process.

42. The method of claim 34, wherein forming a layer of colloidal inorganic oxides on said layer of inorganic oxide comprises performing a wet-on dry or wet-on-semidry process.

43. The method of claim 34, further comprising treating said layer of inorganic oxide with silane coupling agents containing functional groups.
